(19) United States
(12) Patent Application Publication
(10) Pub. No.: US 2002/0068213 A1
(43) Pub. Date: Jun. 6, 2002

(54) Multiple layer electrode for improved performance

(75) Inventors: Mark Kaiser, Arlington Heights, IL (US); James C. Williams, Arlington Heights, IL (US); Di-Jia Liu, Naperville, IL (US)

Correspondence Address: Honeywell International, Inc., Law Dept. AB2, P.O. Box 2245, Morristown, NJ, 07962-9806, US

(73) Assignee: Honeywell International, Inc. Law Dept. AB2, Morristown, NJ (US)

(21) Appl. No.: 09/728,803

(22) Filed: Dec. 1, 2000

(51) Int. Cl. H01M 4/86; H01M 4/88; H01M 8/10; H01M 4/94

(52) U.S. Cl. 429/40; 429/44; 502/101; 429/30

(57) ABSTRACT

In an electrochemical device, such as a fuel cell or electrocatalytic oxidation cell, a catalyst electrode is comprised of a catalytic structure having multiple layers of varied densities to enhance gas diffusion throughout the electrode. A first catalyst layer has a first density, and a second catalyst has a second density that is about 33 to 50% of the first density and any additional layers having a density which are less than the previous layer. A gas diffusion layer is adjacent the second catalyst layer.

### GOVERNMENT RIGHTS

This invention was made with Government support under Contract No. DE-FC02-99EE50578 awarded by the Department of Energy. The Government has certain rights in this invention.

### BACKGROUND OF THE INVENTION

The present invention generally relates to electrodes for fuel cells and, more particularly, to a multiple layer, density-graded catalyst electrode for a fuel cell or other similarly fashioned electrochemical device.

A fuel cell consists of two electrodes separated by an electrolyte. The electrodes are electrically connected through an external circuit, with a resistive load lying in between them. Solid polymer electrochemical fuel cells generally employ a membrane electrode assembly (MEA) consisting of a solid polymer electrolyte membrane (PEM), also known as a proton exchange membrane, in contact with two catalyst electrode layers, which are then disposed between two gas diffusion electrodes. The gas diffusion electrodes are formed from porous, electrically conductive sheet material, typically carbon fiber paper or cloth, which allows gas diffusion while maintaining electrical conductivity between the catalyst electrode layer and the external circuit. The PEM readily permits the movement of protons between the electrodes, but is relatively impermeable to gas. It is also a poor electronic conductor, and thereby prevents internal shorting of the cell.

A fuel gas is supplied to one electrode, the anode, where it is oxidized over the catalyst to produce protons and free electrons. The production of free electrons creates an electrical potential, or voltage, at the anode. The protons migrate through the PEM to the other electrode, the positively charged cathode. A reducing agent is supplied to the cathode, where it reacts over the catalyst with the protons that have passed through the PEM and the free electrons that have flowed through the external circuit to form a reactant product. The catalyst is typically platinum-based and located at each interface between the PEM and the respective electrodes so as to induce the desired electrochemical reaction.

In one common embodiment of the fuel cell, hydrogen gas is the fuel and oxygen is the oxidizing agent. The hydrogen is oxidized at the anode to form H⁺ ions, or protons, and electrons, in accordance with the chemical equation:

H₂=2H⁺+2e⁻

The H⁺ ions traverse the PEM to the cathode, where they are reduced by oxygen and the free electrons from the external circuit, to form water. The foregoing reaction is expressed by the chemical equation:

½O₂+2H⁺+2e⁻=H₂O

One class of fuel cells uses a solid PEM formed from an ion exchange polymer, such as polyperfluorosulfonic acid, e.g., Nafion® manufactured by E. I. DuPont de Nemours. Ion transport is along pathways of ionic networks established by the anionic (sulfonic acid anion) groups that exist within the polymer. Water is required around the ionic sites in the polymer to form conductive pathways for ionic transport.

However, current preparation methods of fuel cell electrodes limit the diffusion of gaseous reactants to the surface of the electrode catalyst. Some methods utilize the application of heat and pressure to laminate a layer of electrocatalyst to the surface of the proton exchange membrane, while others utilize silk screening, painting or other similar methodology to transfer the catalyst to the surface of the proton exchange membrane. These application processes act to develop an interaction between the ion exchange polymer network within the catalyst layer and the proton exchange membrane. This interaction is critical to the proton transfer step in the electro-catalytic process.

Yet, there are disadvantages to the above methods. The hot press method is accomplished at an elevated temperature and pressure so that there is a small amount of melt flow associated with the ionomer mixture. However, with the use of elevated pressures, the catalyst layer, consisting of a mixture of carbon supported metal and ionomer particles, is compressed, increasing the packed density of the electrode layer. As this compression occurs, the remaining channels and pathways for gas diffusion are reduced as well. With other methods of application (i.e., painting) the lack of melt flow upon application minimizes the chance for reduced gas diffusion, yet also diminishes the interaction between the catalyst layer and proton exchange membrane.

Another important step of the electro-catalytic process is the mass transfer of reactant from the gas phase to the surface of the electrode catalyst sites. The rate at which the reactant can penetrate the electrocatalyst layer to reach the catalyst surface is dependent on the bulk density of the layer. The bulk density of the layer can be attributed to ionomer content, metal support and the lamination process. For an optimized electrode, the perfect balance between the gas phase mass transfer and proton transfer within the electrode and proton exchange membrane must be balanced for the best overall performance. However, in laminated assemblies, as the thickness of the catalyst layer is increased, from higher loadings of catalyst being used to improve the electrode performance, gas diffusion to the overall surface of the electrode catalyst is decreased. The resulting reduction in the gas has the affect of compromising the realized improvement from additional metal loading. Conversely, low pressure applications result in low proton conductivity between the electrode and the proton exchange membrane. The improvement delivered by the increased catalyst loading is therefore less than expected.

As can be seen, there is a need for an improved catalyst electrode and method of making the same that overcomes the above disadvantages.

### SUMMARY OF THE INVENTION

In one aspect of the present invention, a catalyst electrode comprises a first catalyst layer having a first density and a second catalyst having a second density that is less than the first density.

In another aspect of the present invention, a method of making a catalyst electrode for a fuel cell comprises producing a first catalyst layer having a first density; producing a second catalyst layer adjacent to the first catalyst layer; and creating a density difference between the first and second catalyst layers while also using varied ionomer concentrations.

These and other features, aspects and advantages of the present invention will become better understood with reference to the following drawings, description and claims.

### BRIEF DESCRIPTION OF THE DRAWINGS

FIG. 1 is a partial, exploded schematic view of a PEM fuel cell in which the present invention may be utilized;

FIG. 2 is schematic, cross-sectional view of the multiple layer catalyst electrode of the present invention;

FIG. 3 is a graph of CO concentration versus time for a prior art, single layer catalyst electrode;

FIG. 4 is a graph of CO concentration versus time for a multiple layer catalyst electrode of the present invention;

FIG. 5 is a graph of CO concentration versus time for another prior art, single layer catalyst electrode;

FIG. 6 is a graph of CO concentration versus time for another multiple layer catalyst electrode of the present invention using multiple levels of ionomer concentration.

### DETAILED DESCRIPTION OF THE INVENTION

While multiple layer electrode of the present invention is discussed below in the context of a PEM fuel cell, the scope of the invention is not so limited. Rather, multiple layer electrodes of the present invention can be used for the improved performance in any electrochemical cell requiring the deposition of a catalyst layer on the surface of an electrolyte. For example, the multiple layer electrode of the present invention can be utilized for the preparation of a membrane electrode assembly (MEA) in electrocatalytic oxidation (ECO) cells, such as that described in International Application No. PCT/US99/21 634.

ECO cells utilize the typical structure of a standard PEM fuel cell, but act as a system to remove excess carbon monoxide (CO) from the fuel cell feed stream. Electrocatalytic material at the anode adsorbs excess CO, effectively scrubbing the CO from the feed. The electrocatalytic surface is then regenerated as the system undergoes either galvanic or electrolytic regeneration, forming carbon dioxide as a process waste gas.

In accordance with the present invention, the multi-layer catalyst electrode improves the gas diffusion to the surface of the catalyst while maintaining good proton conductivity across the electrodes. Reducing gas diffusion limitations while maintaining optimal ionomer conductivity allows for more efficient utilization of the available active sites on the catalyst. The improved gas diffusion may be achieved in the present invention by producing the multiple catalyst layers by different techniques. For example, a base application of an electrocatalyst layer, through the decal method, can be used to maintain a strong ionomer contact and mechanical adhesion between the catalyst layer and the ionomer electrolyte or membrane. After the base layer is prepared, successive layers of catalyst may be applied to the surface through a method which utilizes an application technique that results in less pressure being applied to the surface of the catalyst electrode than the previous application. This reduced pressure method is typically accomplished with methods such as painting, spraying, or silk screening, but can also be attempted with a reduced pressure lamination technique. The application of the successive layers of electrocatalyst using a reduced pressure method prevents the compression of the catalyst layers and improves the mass transport of the gas molecules to the metal particles. With this technique, increased catalyst loadings are capable of returning more proportional improvements in performance.

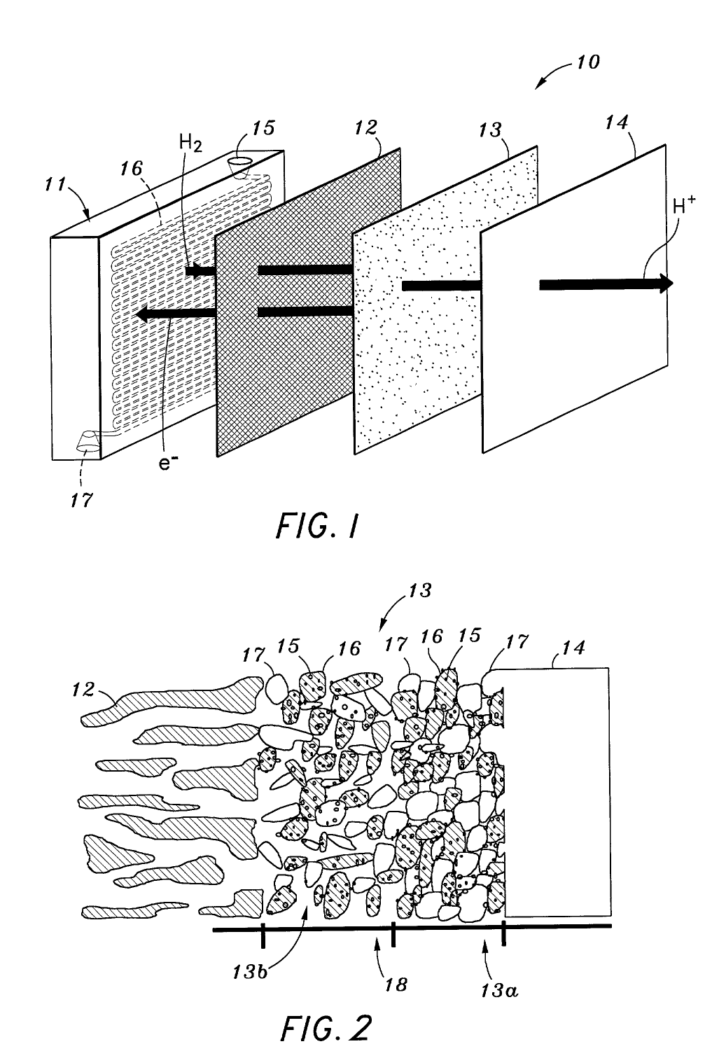

FIG. 1 schematically depicts in an exploded view a partial PEM fuel cell 10 that may include a bipolar plate 11, a gas diffusion layer or electrode 12, a catalyst structure 13, and a proton exchange membrane 14. As depicted by the flow of fuel and electrons, an anode electrode (comprising the gas diffusion electrode 12 and catalyst structure 13) of the fuel cell 10 is shown in FIG. 1. The bipolar plate 11 may be constructed in accordance with any well-known design in the art. PEM cells, including the construction of bipolar plates and membrane electrode assemblies, are described in the article “Polymer Electrolyte Fuel Cells” by S. Gottesfeld and T. A. Zawodzinsk in ADVANCES IN ELECTROCHEMICAL SCIENCE AND ENGINEERING, R. C. Alkire et al. eds., Volume 5, page 195-302, Wiley-VCH, Weinheim, Germany, 1997 and incorporated herein by reference. Thus, the bipolar plate 11 may have a gas feed inlet 15 that can feed a fuel through serpentine gas feed channels 16 and out of a gas feed exhaust 17. The bipolar plate 11, as known in the art, can be made of a conductive, non-porous material such as graphite.

The gas diffusion layer or electrode 12 provides a fuel supply to the catalytic structure 13, an electron transport mechanism to the bipolar plate 11, and can be made of conductive materials with a gas diffusion property such as carbon cloths or porous carbon papers. An example of a commercial electrode 12 material is FI AT™ made by E-TEK, Inc. The gas diffusion layer 12 may be coated with a hydrophobic coating to prevent local flooding by water from the electrochemical process and from a humidified fuel. An example of a suitable hydrophobic material is fluorinated ethylene propylene (FEP).

The gas diffusion electrode 12 is sandwiched by and in contact with the bipolar plate 11 and the catalytic structure 13. The proton exchange membrane 14 is in contact with a side of the catalytic structure 13 opposite the gas diffusion electrode 12. Various materials that are well known in the art can be used as the proton exchange membrane 14, such as perflourinated polymers like NAFION®.

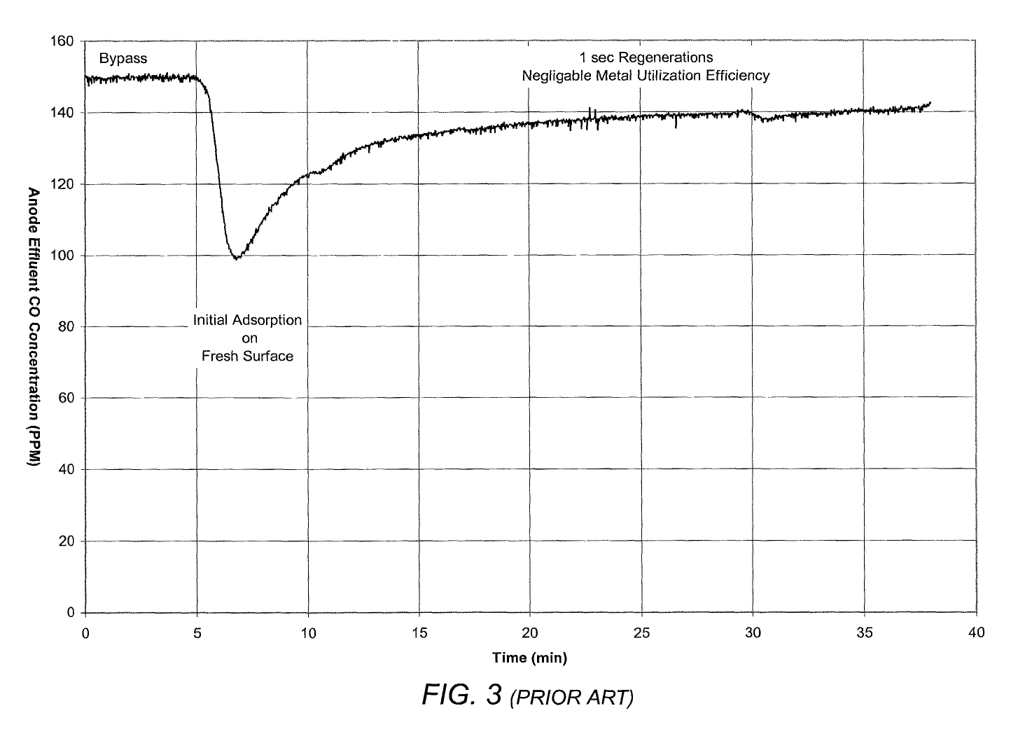

As shown in FIG. 2, the electrode catalytic structure 13 includes multiple layers 13a and 13b, which are shown as being two layers for purposes of illustration. However, as described below, the number of layers can be greater than 2. In each of the layers 13a and 13b, a catalyst metal component 15 may be dispersed over a conductive high surface area support 16. The catalyst metal component 15 and support 16 may be bound to the proton exchange membrane 14 in a matrix of proton conductive ionomer composite 17. The ionomer composite 17 may be recasted from perfluorinated sulfonic acid polymer particles. An example would be NAFION® particles.

The catalyst metal component 15 may include noble metals such as ruthenium, platinum, palladium, rhodium, iridium, gold, silver, etc. Transition metals may also be used for the catalyst metal component 15 and include, for example, molybdenum, copper, nickel, manganese, cobalt, chromium, tin, tungsten, etc. The present invention contemplates that two and three noble and/or transition metals can be used in any combination as the catalyst metal component 15 in the form of a multiple metallic alloy. A “multiple metallic alloy” is intended to refer to any mixture of metals where two or more metals have crystal structures that differ from the original properties of the pure metals. Alternatively, one or two noble metals and/or one or two transition metals be utilized in any form of combinations as a “bimetallic alloy” which is intended to refer to any mixtures of metals containing only two specific metal species that have crystal structures that differ from the original properties of the pure metals.

Although the catalyst metal component 15 in the anode electrode and the cathode electrode (not shown) can be the same, the catalyst metal component 15 at each electrode is preferably different. The preferred catalyst metal component 15 in the cathode includes platinum and platinum-transition metal alloys such as Pt—Co, Pt—Cr. The preferred catalyst metal component 15 in the anode includes ruthenium, rhodium, iridium, palladium, platinum and their corresponding transition metal alloys.

For a noble metal based catalyst metal component 15, the metal loading over the support 16 preferably ranges from about 2 to 70 wt. %. More preferably, the loading is from about 20 to 50 wt. %. Below about 2 wt. %, the net amount of catalyst 15 needed for constructing the electrode maybe too high to fully utilize the metal in an electrochemical process where the proton transfer needs to be connected throughout the electrode. Above 70 wt. %, it is difficult to achieve high metal dispersion which results in lower metal utilization because of the relatively lower surface metal atom to overall metal atom ratio. For a transition metal based catalyst metal component 15, the metal loading preferably ranges from about 0 to 40 wt. % and, more preferably, from about 3 to 30 wt. %. Loading outside such range tends to result in similar types of performance degradation described above for noble metals.

The support 16 is generally characterized as being electrically conductive, chemically inert, and having a high surface area. The conductivity of the support 16 may vary, but is generally comparable to that of carbon. The need for the support 16 to be chemically inert is to avoid reactions between the fuel and the support 16. In a preferred embodiment, the surface area of the support 16 may range from about 5 to 1500 m²/g and, more preferably, range from about 150 to 300 m²/g. Some examples of suitable materials for the support 16 include carbon black, metal nitride and metal carbide such as titanium nitride, tungsten carbide, etc.

The support material 16 supports the catalyst metal component 15 with a high dispersion coefficient. The dispersion coefficient is defined as the ratio of the number of surface atoms of an active catalyst metal to the total number of atoms of the metal particles in the catalyst. In this embodiment, it is preferred that the catalyst metal component 15 be characterized by a dispersion coefficient between about 5 to 100% and, more preferably between about 30 to 90%. If below about 15%, the catalyst surface area provided by the catalyst metal component 15 can be too low to utilize the catalyst metal efficiently. The low utilization of the catalyst metal can result in a higher amount of the catalyst metal needed for the electrode, hence leading to a higher cost of the fuel cell 10.

As mentioned above, the catalytic structure 13 comprises multiple layers 13a, 13b. The first catalyst layer 13a is characterized as having a first density and is in contact with (or affixed to) the proton exchange membrane 14. The second catalyst layer 13b is characterized as having a second density that is less than the first density and in contact with (or affixed to) the first catalyst layer 13a. At the interface of the first and second catalyst layers 13a, 13b is a density boundary 18. What is meant by a “density boundary” is an area of transition between two layers 13a and 13b of electrocatalytic material that has been created by applications of varied pressures. This boundary must maintain both electrical and ionomer pathways, so that both electron pathways and proton pathways are unimpeded.

Preferably, the first metal density is at least about 400 mg/cm³, desirably between 400 mg/cm³ to 2000 mg/cm³ and, more preferably, is between 600 to 1500 mg/cm³. Even more preferably, the first metal density is between 800 and 1000 mg/cm³. The second metal density is preferably not greater than about 500 mg/cm³, desirably between 100 mg/cm³ to 450 mg/cm³ and more preferably, is between 200 mg/cm³ and 400 mg/cm³. As such, the second metal density is preferably about 33 to 50% and even more preferably about 37 to 42% of the first density. Given the density change in the multiple layers 13a and 13b, it can be seen that a density differential is created in the catalyst electrode that comprises the gas diffusion electrode 12 and the catalyst structure 13.

Furthermore, even though the first and second catalyst layer 13a and 13b are of different densities, the catalyst metal component 15 and/or support 16 in each layer may the same or different. For example, the catalyst metal component 15 may be the same in each layer 13a, 13b in order to maintain a uniform electrode structure, assuming that gas diffusion properties and metal particle size are optimized to the chosen level. On the other hand, the catalyst metal component 15 may be different for each layer 13a, 13b where varied levels of metal loading are used to optimize the electrode structure based on gas diffusion levels or properties relating to gas diffusion and ionomer concentration. Likewise, the support 16 may be the same in each layer 13a, 13b in order to maintain a significant level of conductivity and stability between the two density phases, while it may be different for each layer 13a, 13b where varied levels of conductivity or porosity are deemed to be acceptable. Additionally, while illustrated as two individual layers, 13a and 13b, multiple layers of varied density might be appropriate to achieve enhanced performance, thus multiple layers in excess of two may be acceptable or beneficial.

Whether or not an excess of two layers are utilized, the overall thickness of the catalytic structure 13 can vary, but is preferably about 5 μm to 80 μm and, more preferably, about 10 μm to 40 μm thick. Given the foregoing thicknesses for the catalytic structure 13, the first catalyst layer 13a is preferably between about 2 to 20 μm. More preferably, its thickness is about 5 μm to 15 μm. As such, the thickness of the second catalyst layer 13b is about 5 μm to 78 μm and, more preferably about 15 μm to 40 μm thick. Notwithstanding the foregoing, the relative thickness between the first and second catalyst layers 13a, 13b can likewise vary. Accordingly, the relative thickness of the first catalyst layer 13a to the second catalyst layer 13b may preferably be a ratio between about 1:1.2 to 1:39 and, more preferably a ratio between about 1:2 to 1:8.

In making the catalyst electrode and, specifically the catalyst structure 13 of the present invention, two methods in combination may be employed. In general, a first method is preferably employed to form the first catalyst 13a, and a second and different method is employed to form the second catalyst layer 13b. The first method preferably involves compressing a first catalyst material, while the second method involves preventing a compression of a second catalyst material. However, the present invention contemplates that the first and second catalyst layers 13a, 13b may be formed by the same methods while still creating a density boundary between the catalyst layers 13a, 13b and an overall density differential in the catalyst electrode.

Irrespective of the particular method employed, the first method includes compression between about 0 to 5200 psi, preferably between about 125 to 1290 psi, and more preferably between about 250 to 650 psi. In contrast, the second method which includes the prevention of compression nevertheless involves some theoretical compression, such as about 0 to 520 psi, preferably between about 0 to 260 psi, and more preferably between about 0 to 32 psi. In one preferred embodiment of making the catalyst electrode, a “catalyst ink” may be prepared by combining a 5% solution of Nafion™, tetrabutylammonium hydroxide, and a catalyst. The ink may then be transferred to a Teflon™ carrier (or other release agent that can release the ink) by painting, spraying, or other suitable method, until the required loading is achieved. The MEA is then prepared by hot pressing the catalyst to the electrolyte membrane using a heated platen at a temperature of about 180° F. to 450° F. under about 129 to 2580 pounds/in² for about 1 to 20 minutes. After hot pressing, the MEA can be cooled and the Teflon™ carrier removed so as to produce the first catalyst layer 13a. Additional catalyst (i.e., the second catalyst layer 13b) may now added to the electrode by a suitable method, for example, by painting the catalyst on the surface of the first catalyst layer 13a. Although the second catalyst layer 13b may be added in any desired amount, it is preferred that about 50% of the catalyst structure 13 be pressed and about 50% be added thereafter. The MEA may then protonated in a 1M solution of H₂SO₄ for about 1 hour prior to use.

### EXAMPLES

### Example 1

An ECO membrane electrode assembly was prepared as follows. For the anode, an electrocatalyst ink was prepared by mixing 0.38 grams of Ru supported on XC-72R [E-TEK] with 5.40 grams of 1100 EW ionomer solution [Solution Technologies] and 0.38 grams tetrabutyl ammonium hydroxide [Aldrich]. The electrocatalyst ink was allowed to mix in excess of 8 hours. A teflon decal support was coated until a 1.2 mg/cm² loading of electrocatalyst was placed on the support. For the cathode, an electrocatalyst ink was prepared by mixing 0.19 grams of Pt supported on XC-72R [E-TEK] with 1.80 grams of 1100 EW ionomer solution [Solution Technologies] and 0.09 grams tetrabutyl ammonium hydroxide [Aldrich]. The electrocatalyst ink was allowed to mix in excess of 8 hours. A teflon decal support was coated until a 0.3 mg/cm² loading of electrocatalyst was placed on the support. The decals were then transferred to the surface of a Nafion 112 membrane [DuPont] under pressure of 1290 psi with heated platens (411° F.) to form the MEA. The MEA was then loaded into a standard fuel cell test fixture and tested for performance.

FIG. 3 demonstrates the regeneration performance of the MEA by illustrating a graph of carbon monoxide concentration versus time. While initial adsorption of CO was present, the relatively long adsorption curve illustrates poor mass transfer of CO to the catalytic active sites. Additionally, there is no evidence of electrolytic regeneration.

### Example 2

An ECO membrane electrode assembly was prepared as follows. Anode and cathode electrocatalyst inks were prepared as detailed in Example 1. A 0.6 mg/cm² anode decal was prepared using the anode electrocatalyst ink and a 0.3 mg/cm² cathode decal was prepared using the cathode electrocatalyst ink. The decals were then transferred to the surface of a Nafion 112 membrane [DuPont] under 1290 psi with heated platens (411° F.). After pressing, an additional layer electrocatalyst ink electrocatalyst was applied to the surface of the anode, creating a low density layer of electrocatalyst having a loading of 0.6 mg/cm².

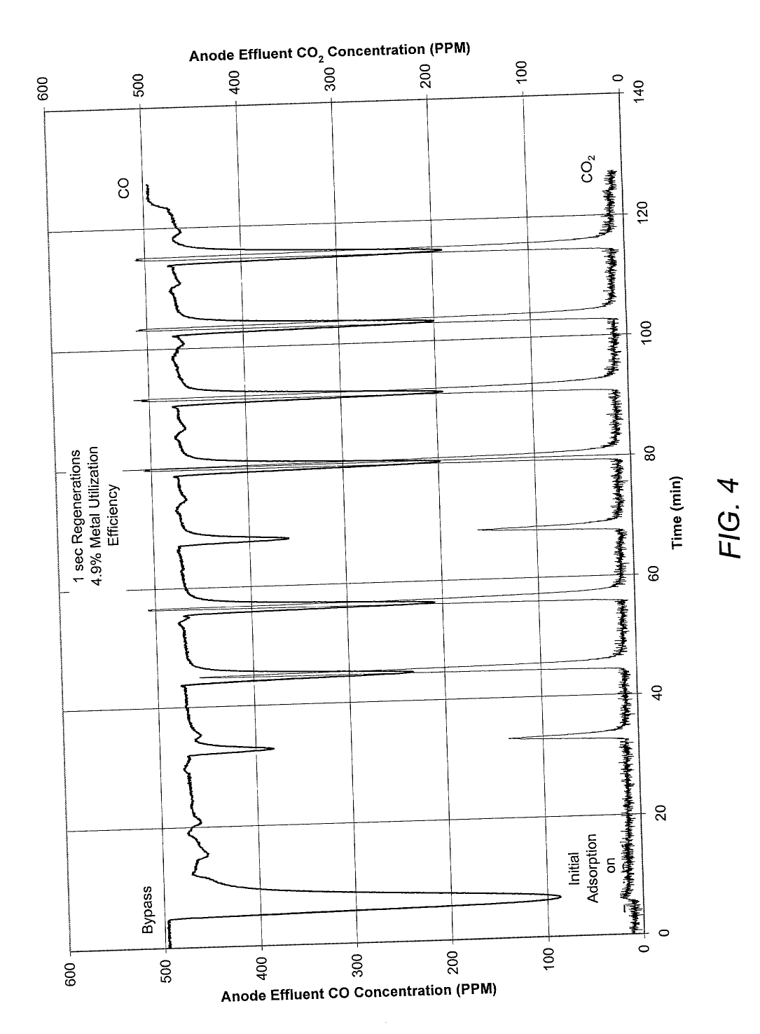

FIG. 4 demonstrates the regeneration performance of the MEA by illustrating a graph of carbon monoxide concentration versus time. Once again, initial adsorption of CO was present but there was a significant increase in the adsorption of CO indicating reasonably good mass transfer of CO to the catalytic active sites. Additionally, there was ample evidence of electrolytic regeneration yielding a 10.2% metal utilization efficiency.

### Example 3

An ECO membrane electrode assembly was prepared as follows. For the anode, an electrocatalyst ink was prepared by mixing 0.19 grams of Ru supported on XC-72R [E-TEK] with 0.90 grams of 1100 EW ionomer solution [Solution Technologies] and 0.19 grams tetrabutyl ammonium hydroxide [Aldrich] . The electrocatalyst ink was allowed to mix in excess of 8 hours. A Teflon™ decal support coated until a 1.2 mg/cm² loading of electrocatalyst was placed on the support. For the cathode, an electrocatalyst ink was prepared by mixing 0.19 grams of Pt supported on XC-72R [E-TEK] with 1.80 grams of 1100 EW ionomer solution [Solution Technologies] and 0.09 grams tetrabutyl ammonium hydroxide [Aldrich]. The electrocatalyst ink was allowed to mix in excess of 8 hours. A Teflon™ decal support was coated until a 0.3 mg/cm² loading of electrocatalyst was placed on the support. The decals were then transferred to the surface of a Nafion 112 membrane [DuPont] under pressure 1290 psi with heated platens (411° F.) to form the MEA. The MEA was then loaded into a standard fuel cell test fixture and tested for performance.

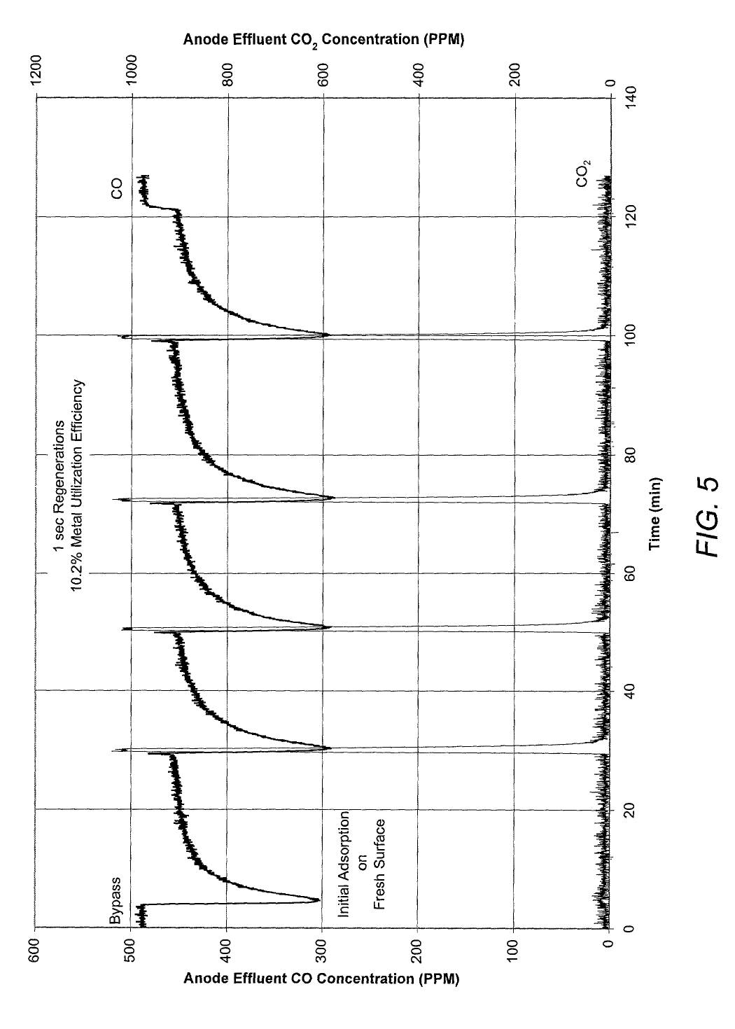

FIG. 5 is a graph of carbon monoxide and carbon dioxide concentration versus time according to the present invention. The same metal loading as Example 1 was used; however, optimization of the anode ionomer was conducted in order to increase the performance of a single high-density layer. Electrolytic regeneration yielded 4.9% metal utilization efficiency that provides a significant performance increase over the non-optimized formula used in Example 1.

### Example 4

An ECO membrane electrode assembly was prepared as follows. Anode and cathode electrocatalyst inks were prepared as detailed in Example 1. A 0.6 mg/cm² anode decal was prepared using the anode electrocatalyst ink and a 0.3 mg/cm² cathode decal was prepared using the cathode electrocatalyst ink. A second electrocatalyst ink was prepared by mixing 0.19 grams of Ru supported on XC-72R [E-TEK] with 1.35 grams of 1100 EW ionomer solution [Solution Technologies] and 0.19 grams tetrabutyl ammonium hydroxide [Aldrich] . The electrocatalyst ink was allowed to mix in excess of 8 hours. The decals were then transferred to the surface of a Nafion 112 membrane [DuPont] under 1290 psi with heated platens (411° F.). After pressing, an additional layer was applied to the surface of the anode, using the second electrocatalyst ink, creating a low density layer of electrocatalyst having a loading of 0.6 mg/cm².

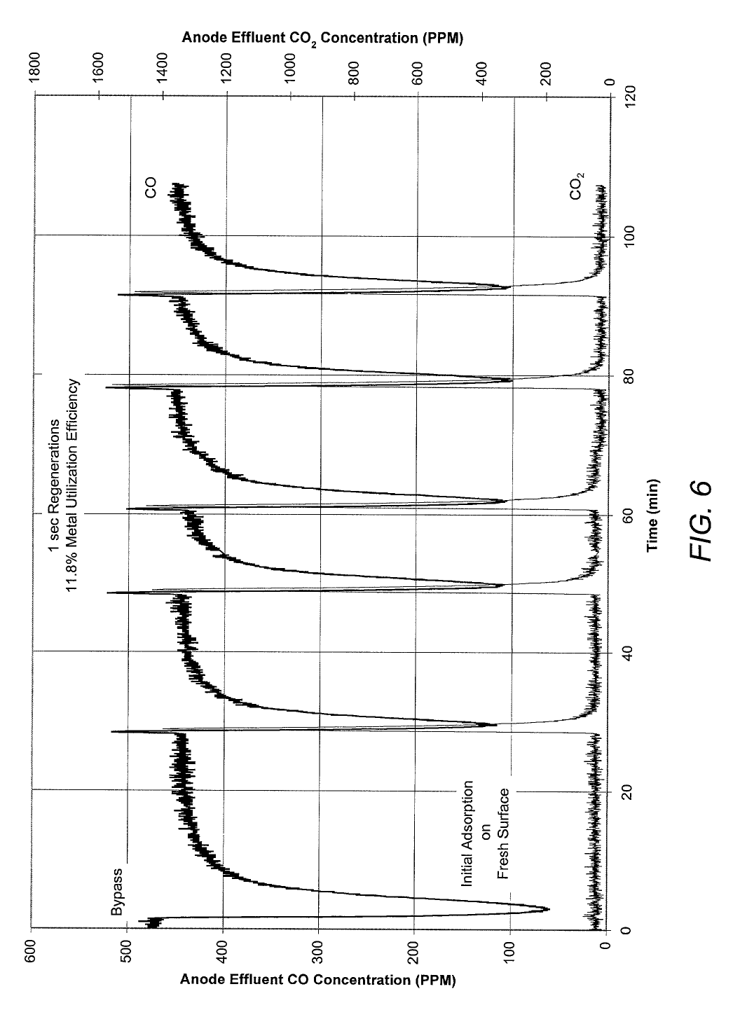

FIG. 6 demonstrates the regeneration performance of the ECO MEA by illustrating a graph of carbon monoxide concentration versus time. Once again, initial adsorption of CO was present but there was a significant increase in the adsorption of CO indicating reasonably good mass transfer of CO to the catalytic active sites, and enhanced mass transfer to sites within the high density layer. Additionally, there was ample evidence of electrolytic regeneration yielding a 11.8% metal utilization efficiency, thus indicating improved performance over the single, low density layer.

It should be understood, of course, that the foregoing relates to preferred embodiments of the invention and that modifications may be made without departing from the spirit and scope of the invention as set forth in the following claims.

We claim:

1. In a fuel cell, a catalyst electrode comprising:
a first catalyst layer having a first density; and
a second catalyst having a second density that is less than said first density.

2. The electrode of claim 1, wherein said fuel cell includes a fuel cell element onto which one of said first and second catalyst layers is operatively affixed.

3. The electrode of claim 2, wherein said first catalyst layer is affixed to said fuel cell element.

4. The electrode of claim 1, wherein said first metal density is at least about 400 mg/cm³.

5. The electrode of claim 1, wherein said second metal density is not greater than about 500 mg/cm³.

6. The electrode of claim 1, wherein said first catalyst layer is produced by a first method and said second catalyst layer is produced by a second method that is different from said first method.

7. The electrode of claim 6, wherein said first method comprises compressing a first catalyst material.

8. The electrode of claim 6, wherein said second method comprises preventing a compression of a second catalyst material.

9. In a fuel cell, a catalyst electrode comprising:
a first catalyst layer having a first density;
a second catalyst having a second density that is about 33 to 50% of said first density; and
a gas diffusion layer adjacent said second catalyst layer.

10. The electrode of claim 9, further comprising a plurality of first catalyst layers.

11. The electrode of claim 9, further comprising a plurality of second catalyst layers.

12. The electrode of claim 9, wherein said first metal density is between about 400 to 1500 mg/cm³.

13. The electrode of claim 9, wherein said second metal density is between about 100 to 500 mg/cm³.

14. The electrode of claim 9, wherein said first catalyst layer is produced by a compressing a first catalyst material and said second catalyst layer is produced by preventing a compression of a second catalyst material.

15. The electrode of claim 14, wherein compressing said first catalyst material comprises hot pressing said first catalyst material to said proton exchange membrane.

16. The electrode of claim 14, wherein preventing a compression of said second catalyst material comprises spraying or painting said second catalyst material to said first catalyst layer.

17. The electrode of claim 14, wherein said first and second catalyst materials are the same.

18. The electrode of claim 14, wherein said first and second catalyst materials are different.

19. The electrode of claim 9, wherein said fuel cell is one of a proton exchange membrane fuel cell and an electrocatalytic oxidation fuel cell.

20. A method of making a catalyst electrode for a fuel cell, comprising:
producing a first catalyst layer having a first density;
producing a second catalyst layer adjacent to said first catalyst layer; and
creating a density boundary between said first and second catalyst layers.

21. The method of claim 20, further comprising creating a density differential in said catalyst electrode.

22. The method of claim 21, wherein creating said density differential comprises:
creating a first density in said first catalyst layer; and
creating a second density in said second catalyst layer that is different from said first density.

23. The method of claim 22, further comprising positioning said first catalyst layer adjacent a proton exchange membrane of said fuel cell.

24. The method of claim 22, further comprising positioning said second catalyst layer adjacent a gas diffusion layer of said catalyst electrode.

25. The method of claim 20, wherein producing said first catalyst layer comprises compressing a first catalyst material.

26. The method of claim 25, wherein compressing said first catalyst material includes hot pressing said first catalyst material onto a fuel cell element.

27. The method of claim 20, wherein producing said second catalyst layer comprises preventing a compression of a second catalyst material.

28. The method of claim 27, wherein preventing a compression of said second catalyst material includes spraying or painting said second catalyst material.

29. The method of claim 27, further comprising applying said second catalyst material onto said first catalyst material.
